(19) United States
(12) Patent Application Publication
(10) Pub. No.: US 2005/0152338 A1
(43) Pub. Date: Jul. 14, 2005

(54) System and method for managing voice communications between a telephone, a circuit switching network and/or a packet switching network

(76) Inventors: Christopher Yao Wen Chen, San Francisco, CA (US); Victor Zhiping Zhao, San Francisco, CA (US)

Correspondence Address: Wilson & Ham;PMB: 348, 2530 Berryessa Road, San Jose, CA, 95132, US

(21) Appl. No.: 10/758,350

(22) Filed: Jan. 14, 2004

(51) Int. Cl. H04L 12/66

(52) U.S. Cl. 370/352

(57) ABSTRACT

A system and method for managing voice communications routes a first telephone call from a remote source to a remote destination using a second telephone call. The first telephone call is made through a first network, which may be one of a circuit switching network and a packet switching network, while the second telephone call is made through a second network, which is one of the circuit and packet switching network that differs from the first network. The second telephone call is initiated in response to the first telephone call. The first and second telephone calls are then interconnected to connect the remote source to the remote destination.

### FIELD OF THE INVENTION

The invention relates generally to telecommunications systems, and more particularly to a system and method for managing voice communications through a circuit switching network and a packet switching network.

### BACKGROUND OF THE INVENTION

Voice over Internet Protocol (VoIP) technology allows parties to establish telephone calls through the Internet using their computers. Unlike telephone calls made over the traditional Public Switched Telephone Network (PSTN), telephone calls made over the Internet (“VoIP calls”) are currently free of charge, regardless of the distance between the parties and the duration of each call. Consequently, the use of VoIP technology translates into considerable savings in telephone charges for users, especially for international calls.

The minimum requirements to make and receive VoIP calls typically require the use of a headset (or a microphone and a speaker) connected to the soundcard of an Internet-connected computer for each party of a VoIP call to transmit and receive voice information between the parties. Since the headset is tethered to the Internet-connected computer via an electrical wire, a VoIP user is limited in mobility to a set distance from the computer equal to the length of the wire connecting the headset to the computer.

In order to alleviate this limitation, equipments have been developed that allows VoIP users to use standard telephones, including wireless telephones, for VoIP calls. One such equipment of interest is an interface device designed to be connected to a standard telephone, an Internet-connected computer and the PSTN. The interface device includes a switching mechanism so that the telephone can be selectively connected to either the Internet-connected computer or the PSTN. Thus, the interface device allows the telephone to be used either for VoIP calls or for traditional PSTN calls by switching between the Internet-connected computer and PSTN connections.

A concern with the conventional equipments that allow standard telephones to be used for VoIP calls is that these equipments are limited with respect to advance telephone features, such as conference calling and call forwarding features, for the two different types of calls. That is, advance telephone features are not available between a PSTN call and a VoIP call.

In view of this concern, there is a need for a system and method for establishing telephone calls using a circuit switching network, such as the PSTN, and/or a packet switching network, such as the Internet, that enables advance telephone features between different types of telephone calls.

### SUMMARY OF THE INVENTION

A system and method for managing voice communications routes a first telephone call from a remote source to a remote destination using a second telephone call. The first telephone call is made through a first network, which may be one of a circuit switching network and a packet switching network, while the second telephone call is made through a second network, which is one of the circuit and packet switching network that differs from the first network. The second telephone call is initiated in response to the first telephone call. The first and second telephone calls are then interconnected to connect the remote source to the remote destination.

A system for managing voice communications in accordance with an embodiment of the invention includes a computer program running on a computing device in signal communication with a packet switching network and a routing device operatively coupled to the computing device. The computer program is configured to initiate and receive first telephone calls through the packet switching network. The routing device is configured to selectively route signals between the circuit switching network and the packet switching network through the computing device. The routing device is further configured to initiate and receive second telephone calls through the circuit switching network. The routing device is further configured to interconnect one of the first telephone calls and one of the second telephone calls to produce an interconnected call through the routing device.

A method for managing voice communications in accordance with an embodiment of the invention includes establishing a first telephone call initiated from a remote source to a premises of a telephone line subscriber through a first network, the first network being one of a circuit switching network and a packet switching network, establishing a second telephone call initiated from the premises to a remote destination through a second network, the second network being one of the circuit and packet switching networks that differs from the first network, and interconnecting the first telephone call and the second telephone call at the premises to connect the remote source to the remote destination.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a diagram of a system for managing voice communications between a telephone, a circuit switching network and/or a packet switching network in accordance with an embodiment of the present invention.

FIG. 2 is a block diagram of the components of a call routing device included in the system of FIG. 1 in accordance with an embodiment of the invention.

FIGS. 3A and 3B are block diagrams of a switching unit of the call routing device of FIG. 2, illustrating activated and deactivated states of one of the relays of the switching unit.

FIGS. 4A and 4B are also block diagrams of the switching unit of the call routing device of FIG. 2, illustrating activated and deactivated states of the other relay of the switching unit.

FIG. 5 is also a block diagram of the switching unit of the call routing device of FIG. 2, illustrating the default state for the switching unit.

FIG. 6 is a block diagram of a computer of the system of FIG. 1 in accordance with an embodiment of the invention.

FIG. 7 is a flow diagram of a process for making a standard PSTN call using the system of FIG. 1 in accordance with an embodiment of the invention.

FIG. 8 is a flow diagram of a process for making a VoIP call using the system of FIG. 1 in accordance with an embodiment of the invention.

FIG. 9A is a flow diagram of a process for receiving a PSTN call at the system of FIG. 1 when the system is not currently being used for a VoIP call in accordance with an embodiment of the invention.

FIG. 9B is a flow diagram of a process for receiving a PSTN call at the system of FIG. 1 when the system is currently being used for a VoIP call in accordance with an embodiment of the invention.

FIG. 10A is a flow diagram of a process for receiving a VoIP call at the system of FIG. 1 when the system is not currently being used for a PSTN call in accordance with an embodiment of the invention.

FIG. 10B is a flow diagram of a process for receiving a VoIP call at the system of FIG. 1 when the system is currently being used for a PSTN call in accordance with an embodiment of the invention.

FIG. 11 is a flow diagram of a process for conferencing a PSTN call and a VoIP call using the system of FIG. 1 in accordance with an embodiment of the invention.

FIG. 12A is a flow diagram of a process for routing an incoming PSTN call to a remote Internet-connected computer using the system of FIG. 1 in accordance with an embodiment of the invention.

FIG. 12B is a flow diagram of a process for routing an incoming VoIP call to a remote telephone using the system of FIG. 1 in accordance with an embodiment of the invention.

FIG. 13 illustrates different “long distance” telephone calls that can be made using two systems in accordance with an embodiment of the invention.

FIG. 14 is a flow diagram of a method for managing voice communications in accordance with an embodiment of the invention.

### DETAILED DESCRIPTION

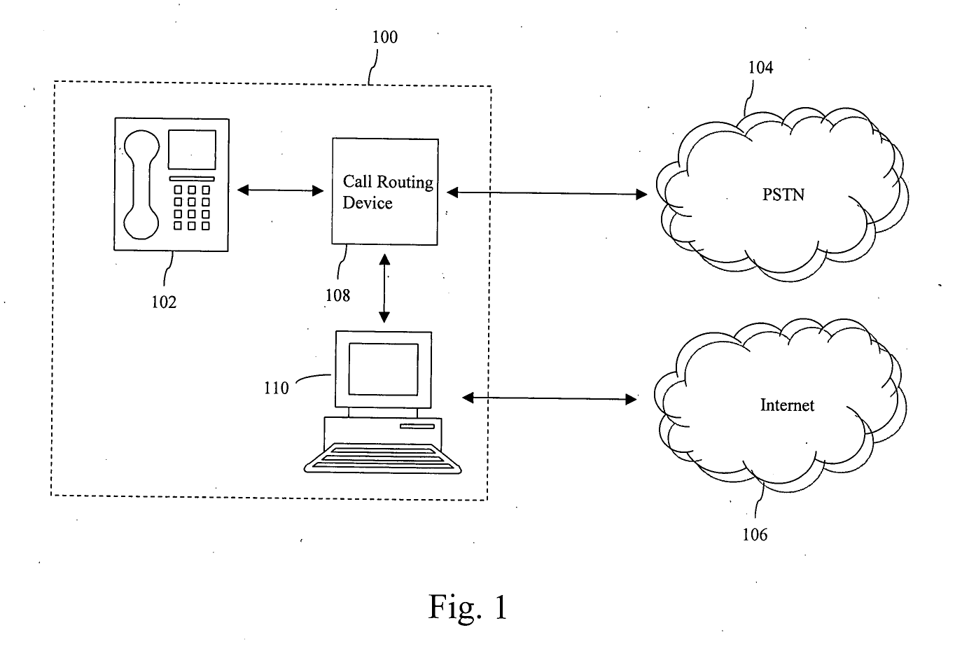

With reference to FIG. 1, a system 100 for managing voice communications (“telephone calls”) between a telephone 102, a circuit switching network 104 and/or a packet switching network 106 in accordance with an embodiment of the invention is shown. Using the system 100, telephone calls can be made and received through the circuit switching network 104 and/or the packet switching network 106. The system 100 can also automatically initiate a telephone call through one of the two networks 104 and 106. In addition, a telephone call through the circuit switching network 104 can be connected to a separate telephone call through the packet switching network 106 at the premises of a telephone line subscriber. Thus, the system 100 enables advance call routing/switching features, such as conferencing and call forwarding, using telephone calls made through the two different networks 104 and 106. In addition, since the system 100 connects the telephone calls through the two different networks 104 and 106 at the premises of a telephone line subscriber, these advance telephone features do not require the services of telephone companies. Furthermore, the system 100 enables other telephone features, such as automatic call denial (form of call screening) and voicemail, as described in below.

As shown in FIG. 1, the system 100 is connected to the circuit switching network 104 and the packet switching network 106. As an example, the circuit switching network 104 and the packet switching network 106 are illustrated in FIG. 1 as the Public Switching Telephone Network (PSTN) and the Internet, respectively. However, the packet switching network 106 can be another type of packet switching network, such as a Local Access Network (LAN) or a Wide Area Network (WAN). Alternatively, the packet switching network 106 may be a combination of same or different packet switching networks. Similarly, the circuit switching network 104 may be another type of circuit switching network or a combination of circuit switching networks. Since the system 100 is connected to both the PSTN 104 and the Internet 106, a user of the system can selectively make a traditional telephone call, referred to herein as a PSTN call, through the PSTN or a Voice over Internet Protocol (VoIP) call through the Internet. As described in detail below, the system 100 also allows calls to be routed between the Internet and the PSTN through the system.

The system 100 includes the telephone 102, a call routing device 108 and a computer 110. The telephone 102 and the computer 110 are both connected to the call routing device 108. Furthermore, the computer 110 is connected to the Internet 106, and the call routing device 108 is connected to the PSTN 104. Thus, the telephone 102 is connected to the Internet 106 via the call routing device 108 and the computer 110, and is also connected to the PSTN 104 via the call routing device 108.

The telephone 102 included in the system 100 can be any standard telephone for making and receiving telephone calls through the PSTN 104. As an example, the telephone 102 may be a standard cordless telephone. In other embodiments, the telephone 102 may be replaced with a microphone, a speaker and a dial pad. Furthermore, in other embodiments, the system 100 may include more than one telephone connected to the call routing device 108 using, for example, one or more dual phone jack adapters. As described in detail below, using the call routing device 108 and the computer 110, any telephone connected to the call routing device 108 can be used to make either a VoIP call or a traditional PSTN call.

In the illustrated embodiment, the computer 110 of the system 100 is a personal computer, such as a desktop computer or a laptop computer. However, in other embodiments, the computer 110 may be any computing device that can be connected to the Internet 106, such as a Personal Digital Assistant (PDA). The computer 110 may be connected to the Internet 106 through any suitable modem, such as a cable modem, Digital Subscriber Line (DSL) modem or a dial-up modem. If a dial-up modem is utilized, two phone lines to the PSTN 104 are preferred so that one of the two phone lines can be used for establishing a standard PSTN call and the other phone line can be used for establishing an Internet connection for a VoIP call. However, the system 100 can be operated using a single connection to the Internet 106 via, for example, a cable modem, a DSL modem or a dial-up modem, although such configuration will limit some of the features of the system, in particular, features that require separate connections to both the PSTN 104 and the Internet 106.

The call routing device 108 is an intelligent interface device that can selectively provide a communications link between the telephone and the PSTN 104 and/or a communications link between the telephone 102 and the Internet 106 via the computer 110 for a VoIP call. In addition, the call routing device 108 can connect a PSTN call and a VoIP call. Thus, the call routing device 108 can be used to conference a PSTN call and a VoIP call using the telephone 102. Furthermore, the call routing device 108 can automatically initiate either a PSTN call through the PSTN 104 or a VoIP call through the Internet 106 and then connect that call to an existing call, which may either be a PSTN call or a VoIP call. As an example, the call routing device 108 can receive a PSTN call from the PSTN 104, and in response, automatically initiate a VoIP call through the Internet 106 and then connect the VoIP call with the received PSTN call for call routing.

The call routing device 108 operates in conjunction with an accompanying program running on the computer 110. The accompanying program performs functions to execute various operations of the system 100. The accompanying program and its functions are described in more detail below. In the illustrated embodiment, the call routing device 108 is a separate device from the telephone 102 and the computer 110. In other embodiments, the call routing device 108 may be integrated into the telephone 102 or the computer 110.

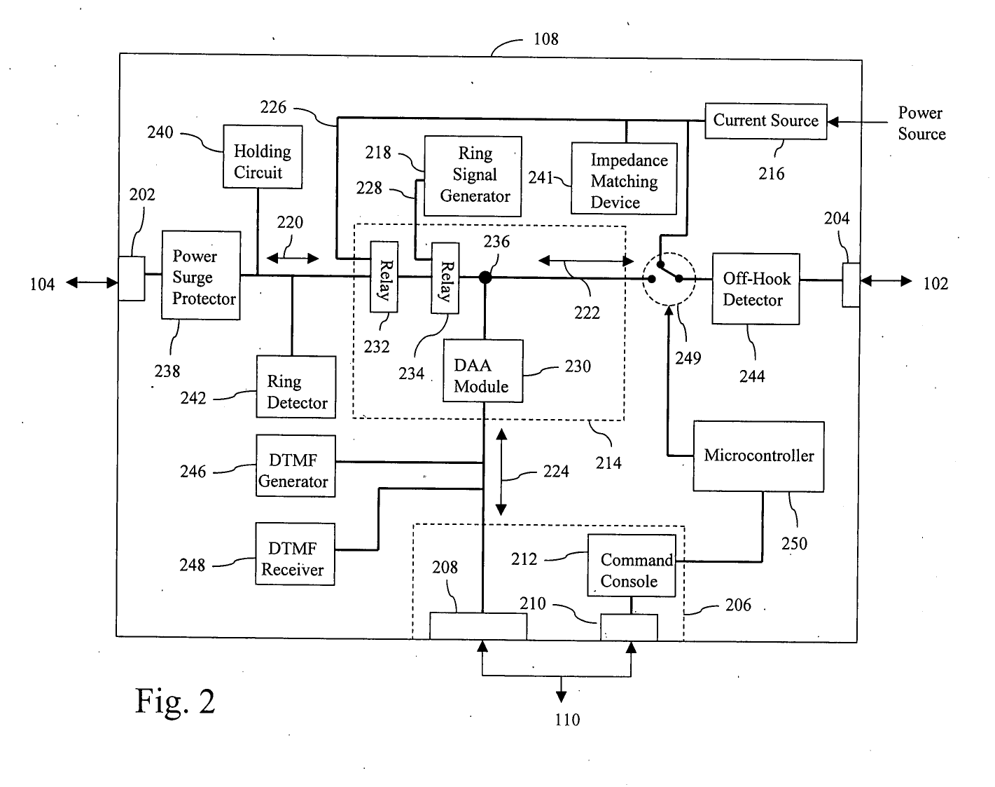

Turning now to FIG. 2, a block diagram of the components of the call routing device 108 in accordance with an embodiment of the invention is shown. The call routing device 108 includes RJ11 ports 202 and 204 (“telephone jacks”) and a computer port 206, which are interfaces to the telephone 102, PSTN 104 and the computer 110. The RJ11 port 202 is used to connect the call routing device 108 to the PSTN 104, while the other RJ11 port 204 is used to connect the call routing device to the telephone 102. The computer port 206 is used to connect the call routing device 108 to the computer 110. In this embodiment, the computer port 206 includes a voice port 208, which is connected to the soundcard of the computer 110, and an RS232 port 210, which is connected to the RS232 port of the computer. The computer port 206 also includes a command console 212, which codes and decodes signals transmitted between the call routing device 108 and the computer 110 through the RS232 port. In other embodiments, the computer port 206 may be any type of computer interface port that can be used to interface with a computer for voice and data transmissions, such as a Universal Serial Bus (USB) port, or any type of terminal that can be connected to the internal bus of the computer 110. In still other embodiments, the computer port 206 may be a wireless transceiver to interface with a computer for voice and data transmissions, such as a Bluetooth transceiver (BLUETOOTH is a trademark of Bluetooth SIG, Inc.).

The call routing device 108 further includes a switching unit 214, a current source 216 and a ring signal generator 218. The RJ11 and computer ports 202, 204 and 206 are interconnected at the switching unit 214. The RJ11 ports 202 and 204 are connected to the switching unit 214 by signal paths 220 and 222, respectively, while the computer port 206 is connected to the switching unit by a signal path 224. The signal paths 220, 222 and 224 are interconnected at an interconnecting node 236. Although not illustrated in FIG. 2, each of the signal paths 220 and 222 connected to the RJ11 ports 202 and 204 and a part of the signal path 224 directly connected to the interconnecting node 236 includes two electrical lines that correspond to “tip” and “ring” lines. The switching unit 214 operates to selectively connect the signals paths 220, 222 and 224 so that voice communication signals can be transmitted between the telephone 102, the PSTN 104 and/or the computer 110. The current source 216 and the ring signal generator 218 are connected to the switching unit 214 via electrical lines 226 and 228, respectively. Although not shown, the current source 216 is electrically connected to other components of the call routing device 108 to provide electrical power in the form of current.

The switching unit 214 of the call routing device 108 includes a data access arrangement (DAA) module 230 and relays 232 and 234. The DAA module 230 is positioned along the signal path 224, while the relays 232 and 234 are serially positioned along the signal path 220. The DAA module 230 can be any commercially available DAA module. As an example, the DAA module 230 may be a DAA module, model XE0092, supplied by Xecom, Inc. Since a DAA module is a common component found in modems, the DAA module 230 is not described in detail herein.

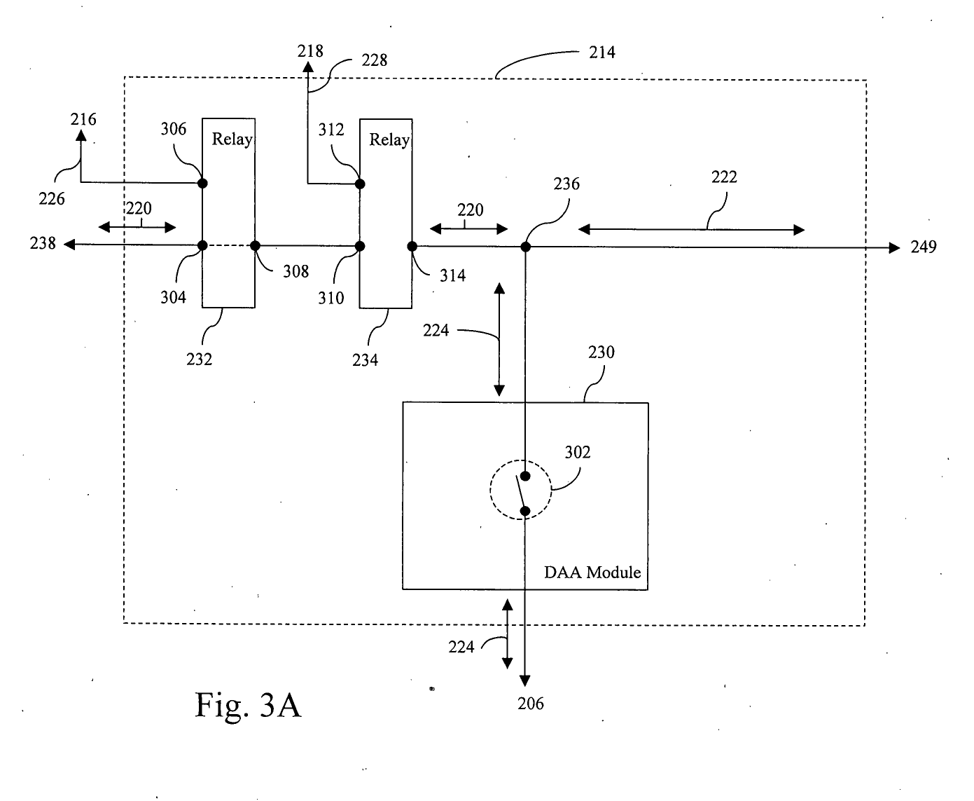

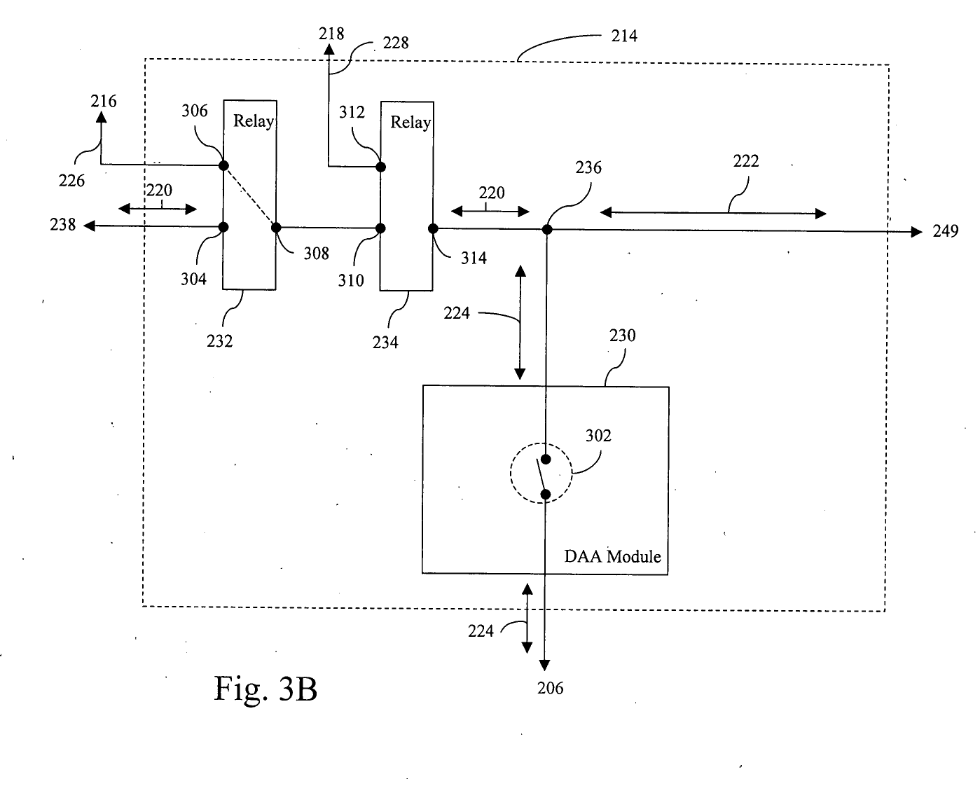

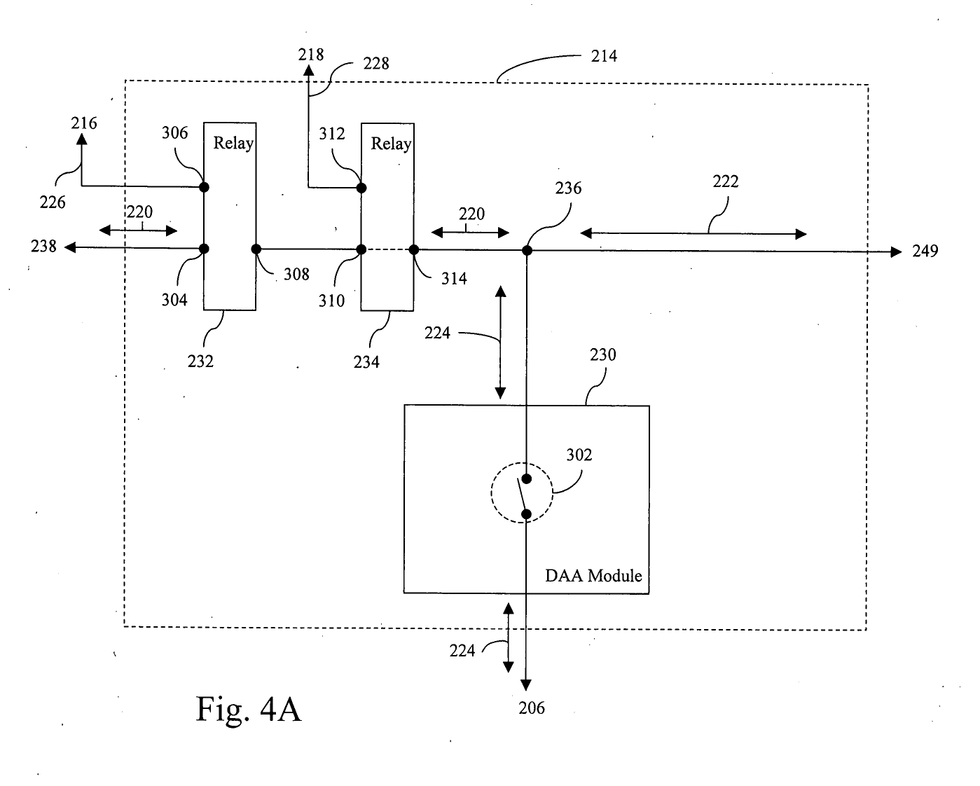

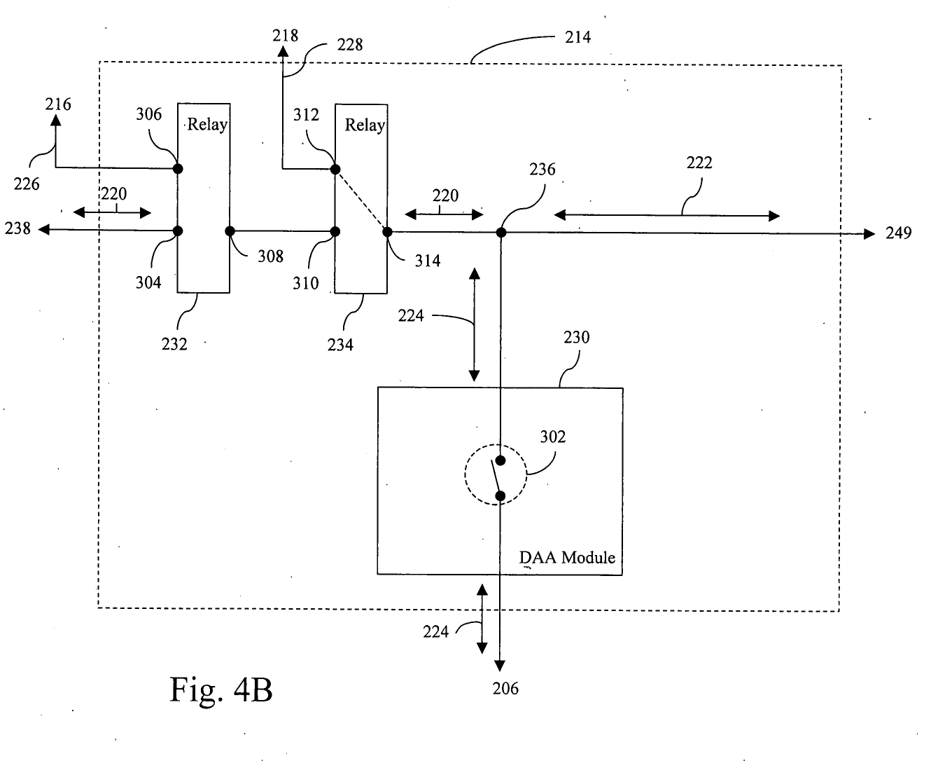

In this embodiment, the DAA module 230 includes an internal switching mechanism, shown as a switch 302 in FIGS. 3A, 3B, 4A and 4B, to selectively disconnect the signal path 224 from the signal paths 220 and 222. Thus, the DAA module 230 can provide voice signal isolation of the Internet-connected computer 110 from the telephone 102 and the PSTN 104. When the call routing device 108 is used exclusively for a standard PSTN call, the internal switch 302 of the DAA module 230 is opened to disconnect the signal path 224 from the telephone 102 and the PSTN 104 since a voice communications link to the Internet 106 via the computer 110 is not needed. The internal switch 302 can also be selectively opened during a conference session between a PSTN call and a VoIP call to isolate the VoIP call from the standard phone call for privacy and during the initiation of a PSTN call for a conference session when a VoIP call has already been established. Initially, the internal switch 302 of the DAA module 230 is opened until instructed to close, as described below. The DAA module 230 also includes various electronic components (not shown) to provide: isolation of sensitive electronic components of the call routing device 108 from the higher voltage on the telephone line which is present on the signal path 220 within the call routing device; two-to-four wire conversion; ring detection; caller identification (ID) detection; and remote disconnect (hang-up) detection.

The relays 232 and 234 operate as switching mechanisms to selectively connect/disconnect the signal path 220 and to selectively connect/disconnect the current source 216 and the ring signal generator 218, respectively, to the common node 236. The relay 232 is used to disconnect the signal path 220 to isolate the PSTN 104 from the telephone 102 and the Internet-connected computer 110. In addition, the relay 232 is used to connect the current source 216, which is connected to an external power supply, to the common node 236 via the electrical line 226 to provide power in the form of current to the telephone 102 and the front-end of the DAA module 230 when the PSTN 104 is disconnected from the telephone and the DAA module. Thus, the power from the current source 216 replaces the power supplied from the PSTN 104. Similarly, the relay 234 is used to disconnect the signal path 220 and to connect the ring signal generator 218 to the common node 236 via the electrical line 228 to transmit ring signals to the telephone 102.

As shown in FIGS. 3A, 3B, 4A and 4B, the relay 232 includes two terminals 304 and 306 on one side (“left terminals”) and a single terminal 308 on the other side (“right terminal”). The left terminal 304 of the relay 232 is connected to the signal path 220, while the other left terminal 306 is connected to the current source 216 via the electrical line 226. In this embodiment, the current source 216 is an AC-to-DC converter that receives alternating current from an external power supply and provides a stable direct current. In other embodiments, the current source 216 may provide direct current using one or more batteries. The right terminal 308 of the relay 232 can be connected to the common node 236 via the second relay 232, and thus, can be connected to the telephone 102 via the signal path 222.

In one state, e.g., when the relay 232 is not activated, as illustrated in FIG. 3A, the left terminal 304 is connected to the right terminal 308, and thus, the PSTN 104 can be connected to the telephone 102 via the second relay 234. Thus, the current source 216 is not connected to the signal path 220. In another state, e.g., when the relay 232 is activated, as illustrated in FIG. 3B, the left terminal 304 is disconnected from the right terminal 308 and the other left terminal 306 is connected to the right terminal 308. Thus, in this state of the relay 232, the current source 216 can be connected to the signal path 220 and to the common node 236 via the signal path 220 through the second relay 234. Since the telephone 102 and the DAA module 302 are connected to the common node 236, this power from the current source 216 is supplied to the front-end of the DAA module 230 and to the telephone 102.

Similar to the first relay 232, the second relay 234 includes left terminals 310 and 312 and a right terminal 314. The left terminal 310 of the relay 234 is connected to the right terminal 308 of the relay 232, while the other left terminal 312 is connected to the ring signal generator 218 via the electrical line 228. The right terminal 314 of the relay 234 is connected to the common node 236, and thus, can be connected to the telephone 102 via the signal path 222. The ring signal generator 218 provides electrical signals (“ring signals”) to ring the telephone 102 in response to an incoming VoIP call. For a standard PSTN call, the ring signals are provided by the nearest central office (not illustrated) of the PSTN 104. However, for a VoIP call, the ring signals must be generated locally. The ring signal generator 218 serves this purpose. The signals provided by the ring signal generator 218 can differ from the signals provided by the central office so that a different ring pattern will be produced by the telephone 102 for a VoIP call, allowing a listener to readily distinguish between an incoming VoIP call and an incoming standard PSTN call.

In one state, e.g., when the relay 234 is not activated, as illustrated in FIG. 4A, the left terminal 310 is connected to the right terminal 314, and thus, the PSTN 104 or the current source 216 can be connected to the telephone 102 through the relay 234. In another state, e.g., when the relay 234 is activated, as illustrated in FIG. 4B, the left terminal 310 is disconnected from the right terminal 314 and the other left terminal 312 is connected to the right terminal 314. In this state of the relay 234, the ring signal generator 218 is connected to the common node 236, and thus, can be connected to the telephone 102 so that ring signals from the ring signal generator are transmitted to the telephone to ring the telephone in response to an incoming VoIP call.

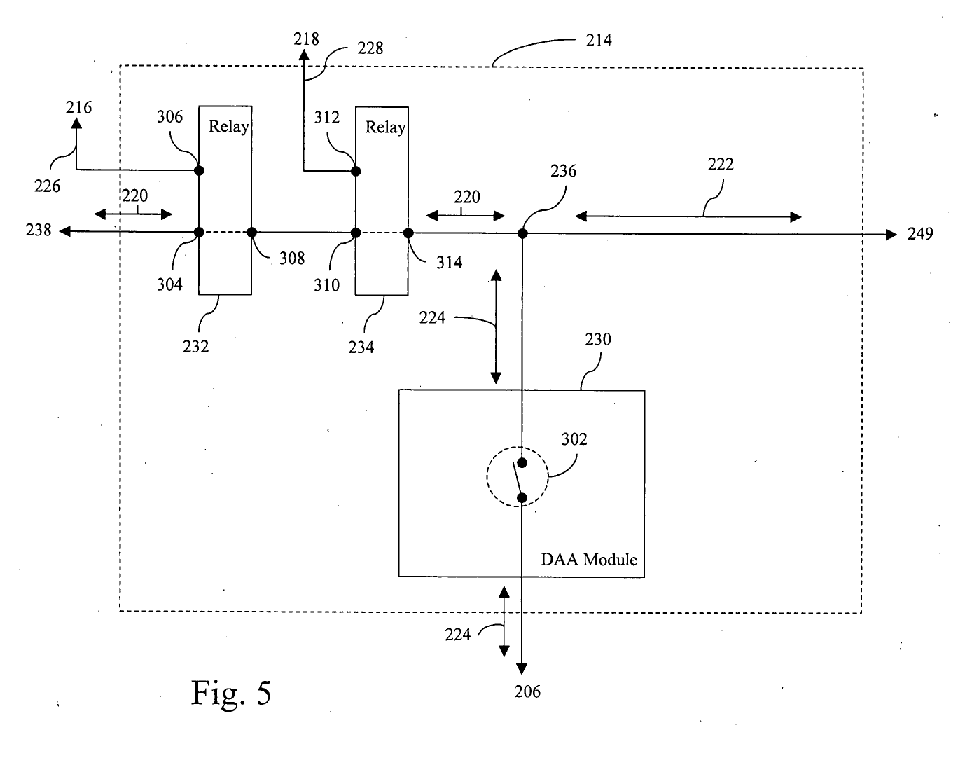

FIG. 5 illustrates the default state for the switching unit 214. In this default state, the relays 232 and 234 are both deactivated. Thus, for the relay 232, the left terminal 304 is connected to the right terminal 308. Similarly, for the relay 234, the left terminal 310 is connected to the right terminal 314. Consequently, in the default state of the switching unit 214, the PSTN 104 can be connected to the telephone 104 via the signal paths 220 and 222.

Turning back to FIG. 2, the call routing device 108 further includes a power surge protector 238, a holding circuit 240, an impedance matching device 241, a ring detector 242, an off-hook detector 244, a dual tone multi-frequency (DTMF) generator 246, a DTMF receiver 248, a switching mechanism 249 and a microcontroller 250. The power surge protector 238 is coupled to the RJ11 port 202 to protect other components of the call routing device 108 against power surges from the PSTN 104. The holding circuit 240 is connected to the signal path 220 between the power surge protector 238 and the switching unit 214. The holding circuit 240 operates to maintain a closed electrical loop between the “tip” and “ring” lines of the signal path 220 to place a standard PSTN call on hold, e.g., during an initiation of a VoIP call.

The impedance matching device 241 is connected to the electrical line 226 that connects the current source 216 to the relay 232 of the switching unit 214. The impedance matching device 241 provides impedance that matches the impedance on the line to the PSTN 104 when the PSTN is disconnected by the relay 232 of the switching unit 214, which results in a more effective echo cancellation by the DAA module 230. As an example, the impedance matching device provides a 600 Ohm resistance.

The ring detector 242 is also connected to the signal path 220 between the power surge protector 238 and the switching unit 214. The ring detector 242 operates to detect ring signals from the PSTN 104, indicating an incoming PSTN call. The ring detector 242 is used when the signal path 220 is disconnected by the relay 232 of the switching unit 214 since the DAA module 230 cannot then be used to detect ring signals from the PSTN 104. The off-hook detector 244 is located on the signal path 222 between the switching unit 214 and the RJ11 port 204. The off-hook detector 244 operates to detect whether the telephone 102 is on-hook or off-hook.

The DTMF generator 246 is connected to the signal path 224 between the DAA module 230 and the computer port 206. The DTMF generator 246 is used to generate DTMF tones to initiate a PSTN call from the call routing device 108. The DTMF receiver 248 is also connected to the signal path 224 between the DAA module 230 and the computer port 206. The DTMF receiver 248 is used to decode DTMF tones received from the PSTN 104 or the telephone 102 so that commands in the form of DTMF tones can be used to operate the call routing device 108 and/or the accompanying program running on the computer.

The switching mechanism 249 is located on the signal path 222 between the switching unit 214 and the off-hook detector 244. The switching mechanism 249 operates to selectively connect the off-hook detector 244 to either the switching unit 214 or the current source 216. Thus, the telephone 102 can be disconnected from the PSTN 104 and the Internet-connected computer 110, and be connected to the current source 216 by the switching mechanism 249. The default state of the switching mechanism 249 is to connect the off-hook detector 244 to the current source 216 so that the off-hook detector can receive power and remain in operation. This default state is changed when the switching mechanism 249 is instructed by the microcontroller 250 to connect the off-hook detector 244 to the switching unit 214. Consequently, the telephone 102 can then be connected to the PSTN 104 through the switching unit 214. The switching mechanism 249 is designed such that when there is a loss of power to the call routing device 108, the switching mechanism 249 is set to connect the off-hook detector 244 to the switching unit 214 so that the telephone 102 can be used. As described further below, the switching mechanism 249 can be used to prevent someone from listening to a telephone call established through the Internet-connected computer 110 and the PSTN 104 using the telephone 102. Furthermore, the switching mechanism 249 can be used to prevent the telephone 102 from receiving ring signals of an incoming telephone call from the PSTN 104 until a caller ID information of the call has been received and approved. In this embodiment, when the telephone 102 is connected to the current source 216 by the switching mechanism 249, a signal indicating that the telephone is disconnected from the Internet-connected computer 110 and the PSTN 104 is provided by the microcontroller 250. In other embodiments, this signal may be provided by another device, which may provide the signal in the form of a recorded audio message.

The microcontroller 250 is connected to all the active components of the call routing device 108. The microcontroller 250 controls or receives information from these active components so that the call routing device 108 can perform various operations, as described in detail below. The microcontroller 250 can also modulate the ring signals generated by the ring signal generator 218 by repeatedly and selectively activating and deactivating the relay 234 of the switching unit 214 so the ring pattern produced by the telephone 102 in response to the modulated ring signals can be controlled.

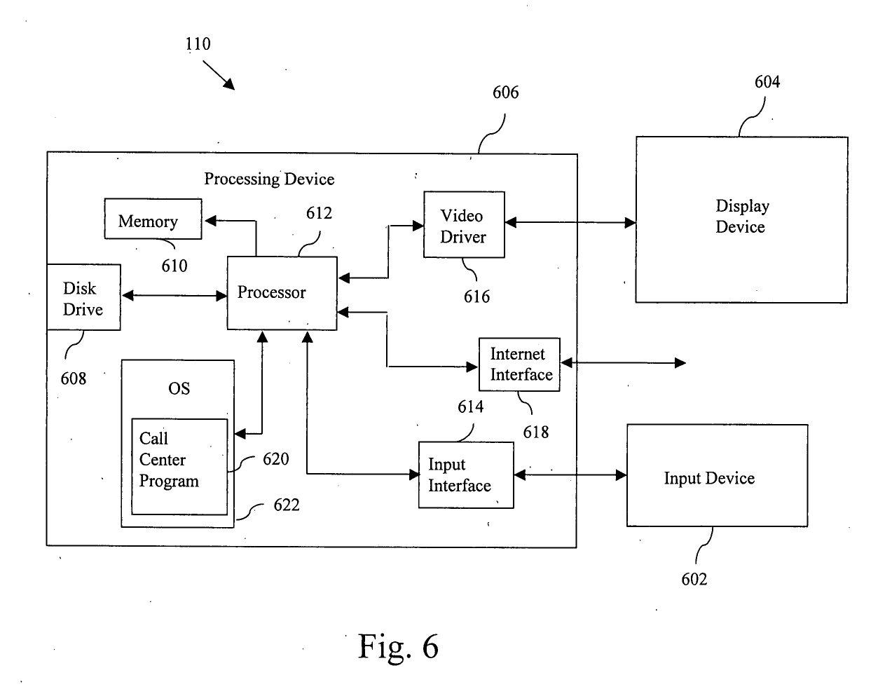

Turning now FIG. 6, a block diagram of the components of the computer 110 in accordance with an embodiment of the invention is shown. The computer 110 includes an input device 602, a display device 604 and a processing device 606. Although these devices are shown as separate devices, two or more of these devices may be integrated together. The input device 602 allows a user to input commands into the computer 110. The input device 602 may include a computer keyboard and a mouse. The input device 602 may also include a microphone for entering voice commands into the system 110. However, the input device 602 may be any type of electronic input device, such as buttons, dials, levers and/or switches on the processing device 606. Alternatively, the input device 602 may be part a touch-sensitive display that allows a user to input commands using a stylus. The display device 604 may be any type of a display device, such as those commonly found in personal computer systems, e.g., CRT monitors or LCD monitors.

The processing device 606 of the computer 110 includes a disk drive 608, memory 610, a processor 612, an input interface 614, a video driver 616 and an Internet interface 618. The processing device 606 further includes a call center program 620 running on an operating system 622. The call center program 620 is the accompanying program for the call routing device 108 operates with the call routing device to perform various call management operations. In one embodiment, the call center program 620 is implemented as software. In this embodiment, the call center program 620 may be installed in the computer 110 from a portable computer readable storage medium, such as a compact disk (CD), having instructions that are executable by the processor 612. However, the call center program 620 may be implemented in any combination of hardware, firmware and/or software.

The disk drive 608, the memory 610, the processor 612, the input interface 614, the video driver 616 and the modem 618 are components that are commonly found in personal computers. The disk drive 608 provides a means to input data into the computer 110 from a portable storage medium. As an example, the disk drive 608 may a CD drive to read data from an inserted CD. The memory 610 is a storage medium to store various data utilized by the computer 110. The memory 610 may be a hard disk drive, read-only memory (ROM) or other forms of memory. The processor 612 may be any type of digital signal processor that can run the call center program 620. The input interface 614 provides an interface between the processing device 606 and the input device 602. The video driver 616 drives the display device 604. The Internet interface 618 provides a connection to the Internet 106. The Internet interface 618 may be a broadband modem, such as a DSL or cable modem, or a dial-up modem that uses the PSTN 104 to connect to the Internet 106. Alternatively, the Internet interface 618 may be a network card, which may be wireless, to connect to a computer network that is connected to the Internet. In order to simplify the figure, additional components that are commonly found in a processing device of a personal computer system are not shown or described.

As stated above, the call routing device 108 operates in conjunction with the call center program 620 running on the computer 110 to perform various operations to enable telecommunication-related functionalities of the system 100, such as making a standard PSTN call and/or a VoIP call, receiving a PSTN call and/or VoIP call, conferencing a PSTN call and a VoIP call, and routing an incoming VoIP call to a remote telephone using a PSTN call and vice versa.

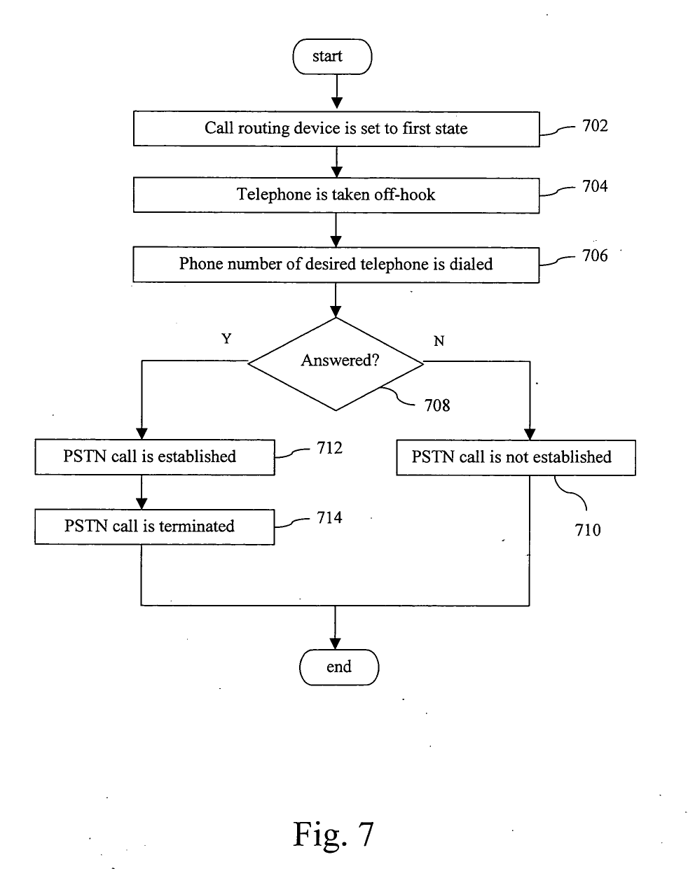

The processes for performing various telecommunication-related operations using the system 100 are now described. The process for making a standard PSTN call using the system 100 in accordance with an embodiment is described with reference to the flow diagram of FIG. 7. At block, the call routing device 108 is set to a first state in which both of the relays 232 and 234 are deactivated, the internal switch 302 of the DAA module 230 is opened, and the switching mechanism 249 is set to connect the off-hook detector 244 to the current source 216. This first state of the call routing device 108 may be the default state for the device. Even though the telephone 102 is disconnected from the PSTN 104 in the first state of the call routing device 108, the telephone 102 can be used in a normal manner to connect to a remote telephone through the PSTN 104. At block 704, the telephone 102 is taken off-hook by the caller to initiate a PSTN call. In addition, at block 704, the internal switch 302 of the DAA module is 230 is closed in response to the telephone 102 being taken off-hook. The closing of the internal switch 302 of the DAA module 230 connects the computer port 206 to the RJ11 port 204, connecting the telephone 102 to the Internet-connected computer 110. Furthermore, at block 704, the switching mechanism 249 is switched to connect the off-hook detector 244 to the switching unit 214 in response to the telephone 102 being taken off-hook, connecting the telephone to the PSTN 104. The off-hook status is detected by the microcontroller 250 via the off-hook detector 244, and then the states of the internal switch 302 and the switching mechanism 249 are changed by the microcontroller in response to the detected off-hook status.

Next, at block 706, the phone number of the desired remote telephone is dialed to send a request in the form of ring signals to establish the PSTN call. Next, at block 708, the ringing remote telephone is either answered or not answered. If the remote telephone is not answered, then the PSTN call is not established, at block 710, and the process comes to an end. If the remote telephone is answered, then the PSTN call is established, at block 712. Next, at block 714, the PSTN call is terminated when one of the two parties of the phone call hangs up the respective telephone.

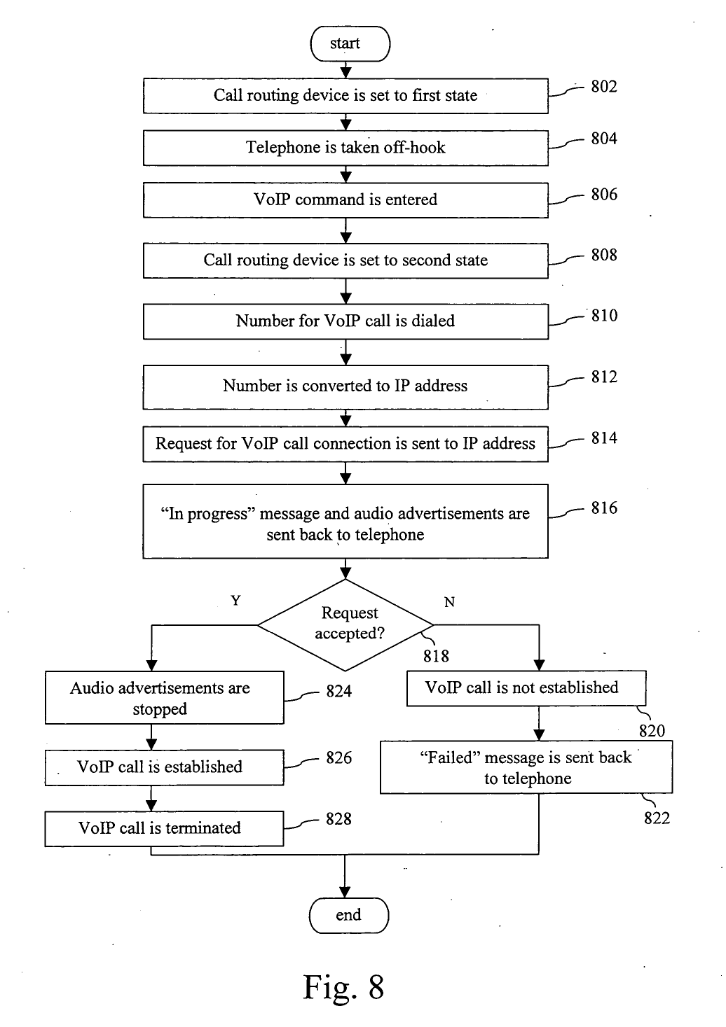

The process for making a VoIP call using the system 100 in accordance with an embodiment is described with reference to the flow diagram of FIG. 8. In one embodiment, a VoIP call is established using an instant messaging network through the Internet 106, such as those provide by MSN or YAHOO. However, any peer-to-peer network or any existing VoIP network through the Internet 106 may be used to establish a VoIP call. Consequently, it is assumed that the computer 110 is connected to the Internet 106 and an instant messaging application is running on the computer.

Initially, at block 802, the call routing device is set to the first state. Next, at block 804, the telephone 102 is taken off-hook by a caller to initiate a VoIP call. In addition, at block 804, the internal switch 302 of the DAA module is 230 is closed and the switching mechanism 249 is switched to connect the off-hook detector 244 to the switching unit 214 in response to the telephone 102 being taken off-hook. Next, at block 806, the caller enters a VoIP command using the telephone dial pad to change the state of the call routing device 108 from the first state to a new second state for making a VoIP call. As an example, the command may be the “#” button on the telephone dial pad. This command in the form of a DTMF tone is received by the DTMF receiver 248 of the call routing device 108 and a signal is then transmitted to the microcontroller 250 of the device. In response, at block 808, the call routing device 108 is set to the second state by the microcontroller 250 in which the relay 232 is activated. The activation of the relay 232 disconnects the signal path 220 and connects the power supply 216 to the telephone 102 and the DAA module 230, as described above.

Next, at block 810, the number associated with the remote Internet-connected computer for the VoIP call is dialed by the caller using the dial pad of the telephone 102. The dialed number can be a single digit number or a multi-digit number, which corresponds to an IP address of the remote computer. The dialed number in the form of DTMF tones is received by the DTMF receiver 248 of the call routing device 108, where each of the received DTMF tones is converted to a corresponding signal and transmitted to the computer 110 via the microcontroller 250 and the computer port 206 of the device. Next, at block 812, the dialed number is converted to the corresponding IP address of the remote Internet-connected computer by the call center program 620 running in the computer 110. Next, at block 814, a request to establish a VoIP call connection is sent to the IP address of the remote Internet-connected computer by the call center program 620. Next, at block 816, an informational voice message is sent back to the telephone 102 by the call center program 620, informing the caller that the VoIP call connection is in progress. Furthermore, one or more audio advertisements may also be sent back to the telephone 102 during the connecting period. These advertisement slots may be a basis for a method for commercializing on the use of the system 100 for VoIP calls. New advertisements may be periodically downloaded to the computer 110 of the system 100 through the Internet 106. Depending on the number of systems, such as the system 100, being used for VoIP calls, such advertisements can reach a large number of audiences, which allows for generation of revenue from the sales of the advertisement slots.

Next, at block 818, the request is accepted or not accepted (timed out) at the remote Internet-connected computer. If the request is not accepted, a VoIP call is not established, at block 820, and another informational voice message may be sent to the telephone 102 by the call center program 620, informing the caller that the VoIP call connection has failed, at block 822. The process then comes to an end. However, if the request is accepted at the remote Internet-connected computer, the audio advertisements are stopped by the call center program 620, at block 824, and the VoIP call is established, at block 826.

The established VoIP call is then terminated, at block 828. The VoIP call is terminated by the call center program 620 when the caller hangs up the telephone 102. The off-hook detector 244 of the call routing device 108 detects the on-hook status of the telephone 102 and sends an on-hook signal to the call center program 620 via the microcontroller 250. In response, the call center program 620 disconnects the VoIP call. The VoIP call is also terminated when the VoIP call connection is disconnected.

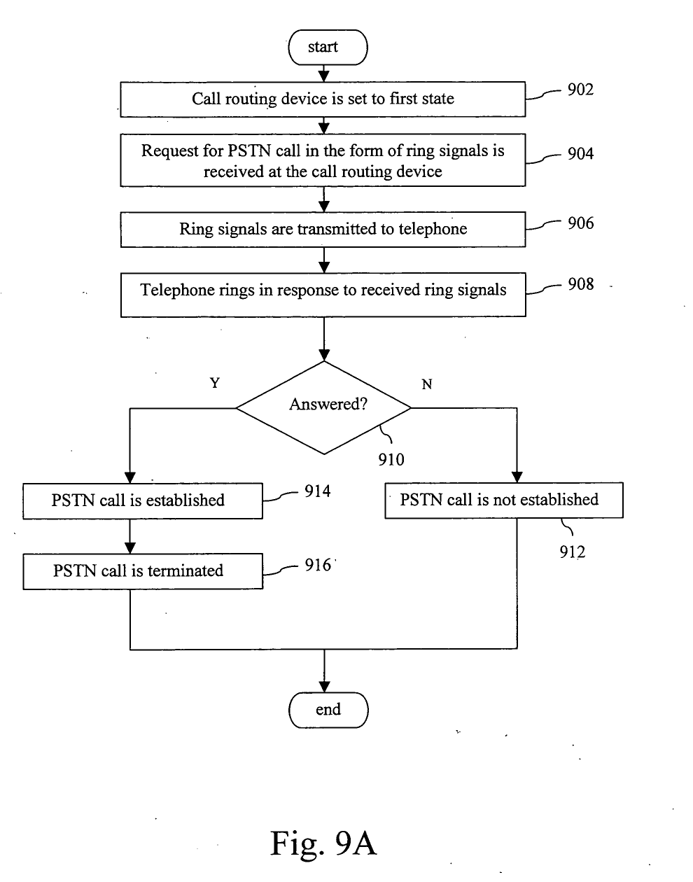

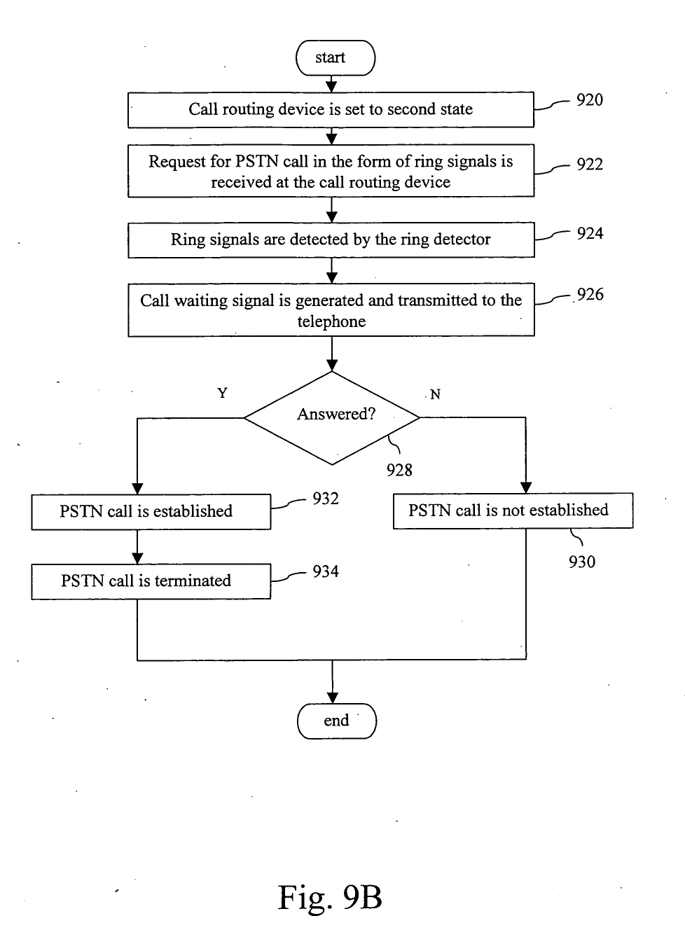

The process for receiving a PSTN call at the system 100 when the system is not currently being used for a VoIP call in accordance with an embodiment is described with reference to the flow diagram of FIG. 9A. Initially, at block 902, the call routing device 108 is set to the first state. Next, at block 904, a request from the PSTN 104 in the form of ring signals to establish a PSTN call is received at the call routing device 108 through the RJ11 port 202. In response, the switching mechanism 249 is switched to connect the switching unit 214 to the off-hook detector 244, connecting the telephone 102 to the switching unit. Since the switching mechanism 249 connects the PSTN 104 to the telephone 102, the received ring signals are transmitted to the telephone 102, at block 906. Next, at block 908, the telephone 102 rings in response the received ring signals. Next, at block 910, the ringing telephone 102 is either answered or not answered. If the telephone 102 is not answered, then the PSTN call is not established, at block 912, and the process comes to an end. If the telephone 102 is answered, then the PSTN call is established, at block 914. Next, at block 916, the PSTN call is terminated when one of the two parties of the phone call hangs up the respective telephone.

The process for receiving a PSTN at the system 100 when the system is currently being used for a VoIP call in accordance with an embodiment is described with reference to the flow diagram of FIG. 9B. Since the system 100 is being used for a VoIP call, the call routing device 108 is initially set to the second state in which the relay 232 is activated, disconnecting the signal path 220 to the PSTN 104. In addition, the switching mechanism 249 is set to connect the telephone 102 to the switching unit 214 and the internal switch 302 of the DAA module 230 is closed, connecting the telephone 102 to the computer 110, at block 920. Next, at block 922, a request from the PSTN 104 in the form of ring signals to establish a PSTN call are received at the call routing device 108 through the RJ11 port 202. Next, at block 924, the received ring signals are detected by the microcontroller 250 of the call routing device 108 via the ring detector 242. Next, at block 926, a call waiting signal is generated and transmitted to the telephone 102 by the microcontroller 250, indicating an incoming PSTN call. As an example, the call waiting signal may be generated by the DTMF generator 246 or the microcontroller 250. Next, at block 928, the incoming PSTN call is either answered or not answered. As an example, the incoming PSTN call can be answered by taking the telephone 102 on-hook and then off-hook in a short period of time, which puts the VoIP call on hold and connects the telephone 102 to the PSTN 104 (i.e., the relay 232 of the call routing device 108 is deactivated). The VoIP call can be placed on hold by opening the internal switch 302 of the DAA module 230 or by muting the VoIP call at the computer 110 by the call center program 620.

If the incoming call is not answered, then the PSTN call is not established, at block 930, and the process comes to an end. If the incoming call is answered, then the PSTN call is established, at block 932. Next, at block 932, the PSTN call is terminated when one of the two parties of the PSTN call hangs up the respective telephone.

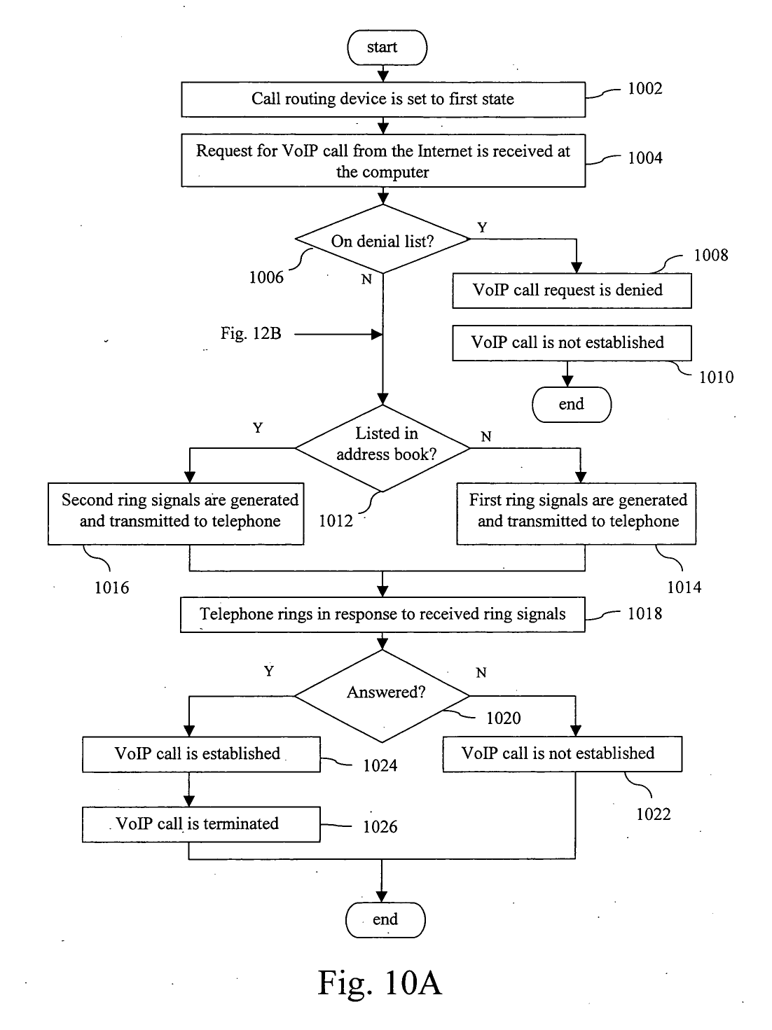

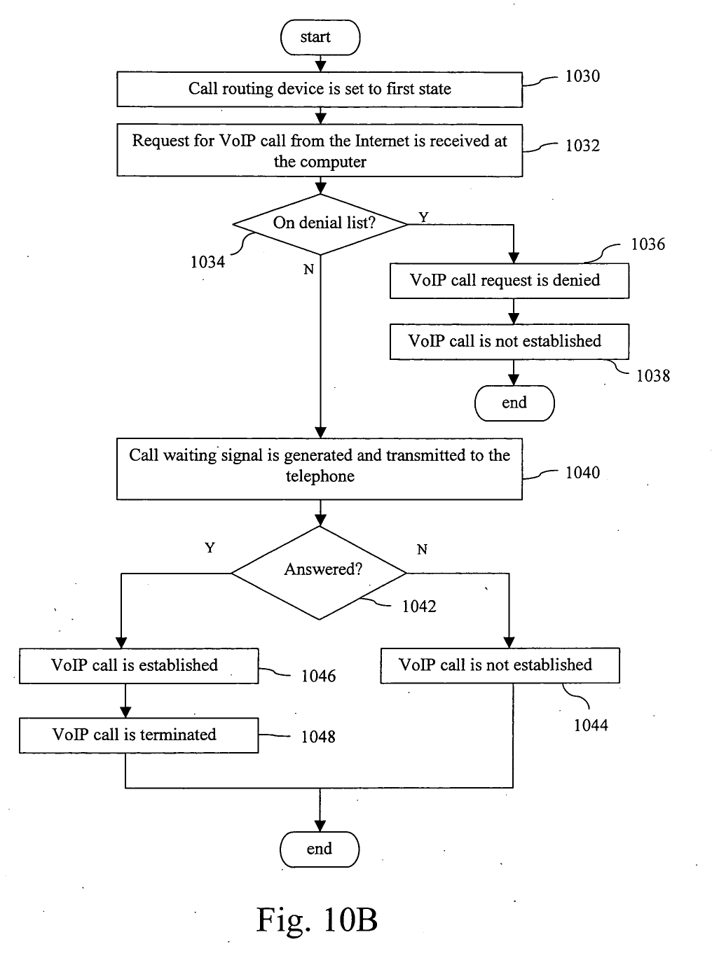

The process for receiving a VoIP call at the system 100 when the system is not currently being used for a PSTN call in accordance with an embodiment is described with reference to the flow diagram of FIG. 10A. Initially, at block 1002, the call routing device 108 is set to the first state. Next, at block 1004, a request for VoIP call from the instant messaging network of the Internet 106 is received at the computer 110. Next, at block 1006, a determination is made by the call center program 620 whether the calling party is on a denial list. The denial list is a list of parties (e.g., IP addresses and phone numbers) from which the user of the system 100 does not want to receive calls. This denial list is stored in the computer 110 and used by the call center program 620.

If the calling party is on the denial list, the VoIP call request is automatically denied by the call center program 620, at block 1008, and the VoIP call is not established, at block 1010. The process then comes to an end. However, if the calling party is not on the denial list, another determination is made by the call center program 620 whether the calling party is listed in an address book, at block 1012. The address book is another list of parties stored in the system 100. Similar to the denial list, the address book is stored in the computer 100 and used by the call center program 620.

If the calling party is not listed in the address book, the switching mechanism 249 is switched to connect the telephone 102 to the switching unit 214 and first ring signals are generated and transmitted to the telephone 102, at block 1014. This is achieved by sending an appropriate signal to the microcontroller 250 of the call routing device 108 by the call center program 620. In response, the microcontroller 250 controls the switching mechanism 249 to connect the telephone 102 to the switching unit 214, the ring signal generator 218 to generate the first ring signals, and the relay 234 to the activated state to transmit the ring signals to the telephone 102. If the calling party is listed in the address book, the switching mechanism 249 is switched to connect the telephone 102 to the switching unit 214 and second ring signals that differ from the first ring signals are generated and transmitted to the telephone 102, at block 1016. This is achieved in a similar manner as the generation and transmission of the first ring signals except that the ring signal generator 218 is controlled to generate different ring signals. The ringing pattern of the telephone 102 depends on the ring signals applied to the telephone. Thus, different ring signals will produce different ringing patterns, which allow a listener to distinguish between calling parties. The ring signals for any calling party listed in the address book may be identical so that the telephone 102 rings with the same ringing pattern when a VoIP call is from any party listed in the address book. Alternatively, the ring signals can vary for each calling party in the address book or for different categories of parties in the address book to distinguish between different calling parties that are listed in the address book. As an example, the ring signals for a calling party in a “business” category of the address book may be different from the ring signals for a calling party in a “friends” category of the address book.

Next, at block 1018, the telephone 102 rings in response the received ring signals. Next, at block 1020, the ringing telephone 102 is either answered or not answered. If the telephone 102 is not answered, then the VoIP call is not established, at block 1022, and the process comes to an end. If the telephone is answered, then the VoIP call is established, at block 1024. Next, at block 1026, the VoIP call is terminated when the called party hangs up the telephone 102 or when the VoIP call connection is disconnected.

The process for receiving a VoIP call using the system 100 when the system is currently being used for a PSTN call in accordance with an embodiment is described with reference to the flow diagram of FIG. 10B. Initially, at block 1030, the call routing device 108 is set to the first state, which allows the PSTN call between the telephone 102 and the PSTN 104. Next, at block 1032, a request for VoIP call from the instant messaging network of the Internet 106 is received at the computer 110. Next, at block 1034, a determination is made by the call center program 620 whether the calling party is on the denial list. If so, the VoIP call request is automatically denied by the call center program 620, at block 1036, and the VoIP call is not established, at block 1038. The process then comes to an end. However, if the calling party is not on the denial list, a call waiting signal is generated and transmitted to the telephone 102, at block 1040. This is achieved by sending a signal to the microcontroller 250 of the call routing device 108 by the call center program 620 to generate a call waiting signal, which may be generated by the DTMF generator 246 or the microcontroller 250.

Next, at block 1042, the incoming VoIP call is either answered or not answered. If the incoming VoIP call is not answered, then the VoIP call is not established, at block 1044, and the process comes to an end. If the incoming call is answered, then the VoIP call is established, at block 1046. As an example, the incoming VoIP call can be answered by taking the telephone 102 on-hook and then off-hook in a short period of time, which puts the PSTN call on hold and connects the telephone to the computer 110. The PSTN call is placed on hold by activating the holding circuit 240 and the relay 232 of the call routing device 108 by the microcontroller 250. Thus, the telephone 102 is disconnected from the PSTN 104, but the telephone line to the PSTN is held active by the holding circuit 240.

Since the VoIP call can also be placed on hold, the telephone 102 can be selectively switched between the PSTN call and the VoIP call using the relay 232 and the internal switch 302 of the DAA module 230 (or by muting the VoIP call by the call center program 620). Next, at block 1048, the VoIP call is terminated when the called party hangs up the telephone or when the VoIP call connection is disconnected.

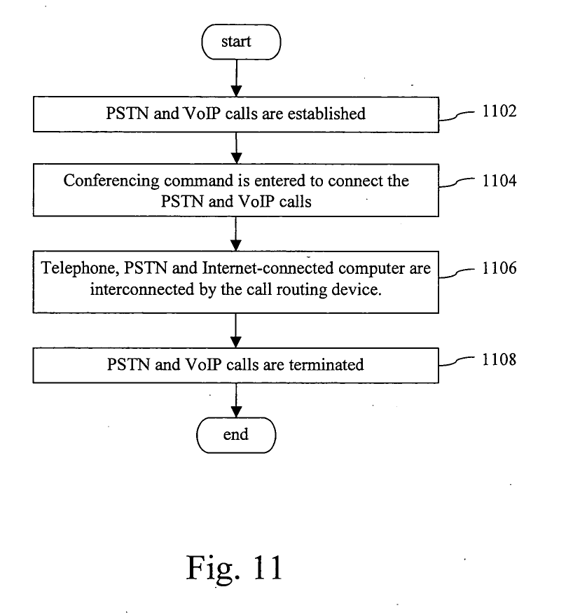

The process for conferencing a PSTN call and a VoIP call using the system 100 in accordance with an embodiment is described with reference to the flow diagram of FIG. 11. At block 1102, a standard PSTN call and a VoIP call with the system 100 are established. Each of these calls may be established by making a new call from the system 100, as described above with reference to FIGS. 7 and 8, or by receiving a call at the system, as described above with reference to FIGS. 9A, 9B, 10A and 10B. The order in which the PSTN and VoIP calls are established does not matter. Next, at block 1104, a conferencing command is entered by the user of the system 100 to connect the PSTN call and the VoIP call. As an example, the conference command can be entered by pressing predefined button(s) on the dial pad of the telephone 102. As another example, the conferencing command can also be entered using the input device 602 of the computer 110 by pressing predefined key(s) on the computer keyboard or by selecting a displayed entry on the screen of the display device 604. Next, at block 1106, the telephone 102, the PSTN 104 and the Internet-connected computer 110 are interconnected by the call routing device 108 to connect the PSTN call and the VoIP call in response to the conferencing command, which creates a three-way conference session formed from the connected calls. The interconnection is achieved by deactivating the relay 232 of the call routing device 108 to connect the PSTN 104 to the telephone 102 or by closing the internal switch 302 of the DAA module 230 to connect the Internet-connected computer 110 to the telephone, depending on the previous state of the relay 232 and the internal switch 302.

After the PSTN and VoIP calls are interconnected by the call routing device 108 for conferencing, these calls may be separated by entering an appropriate command. As an example, the conferencing command may be entered the second time to activate the relay 232 of the call routing device 108 to disconnect the PSTN 104 to the telephone 102 or to open the internal switch 302 of the DAA module 230 to disconnect the Internet-connected computer 110 to the telephone 102. Next, at block 1108, the PSTN and VoIP calls are terminated. The PSTN call is terminated when one of the two parties of the PSTN call hangs up the respective telephone. The VoIP call is terminated when the user hangs up the telephone 102 or when the VoIP call connection is disconnected.

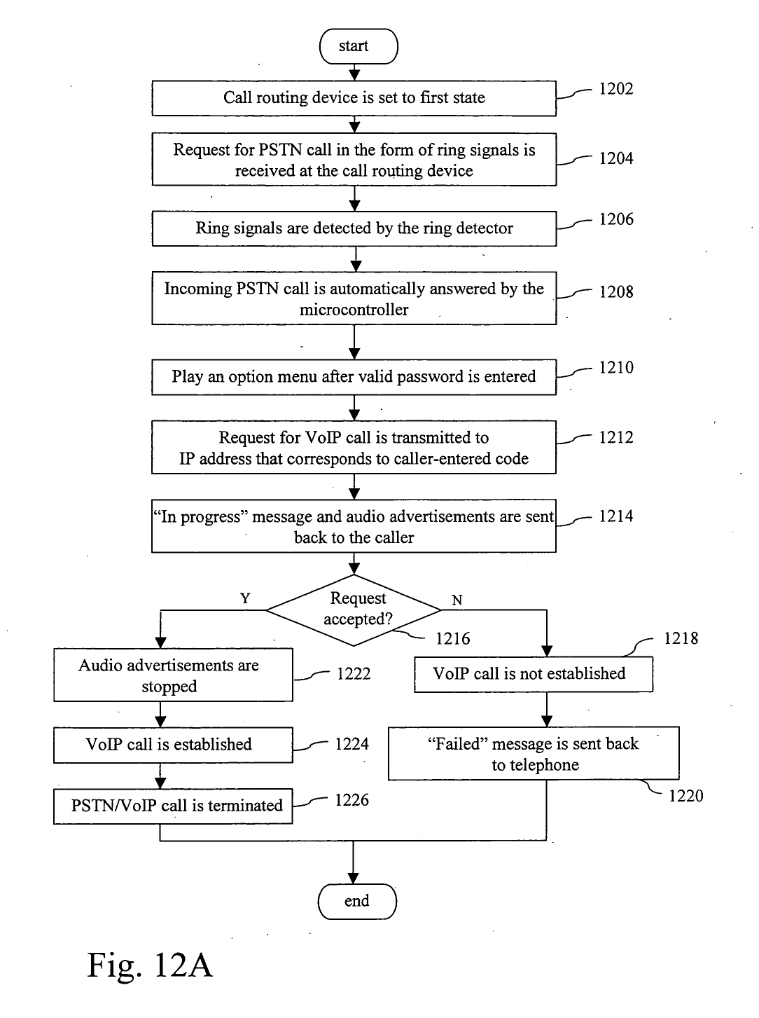

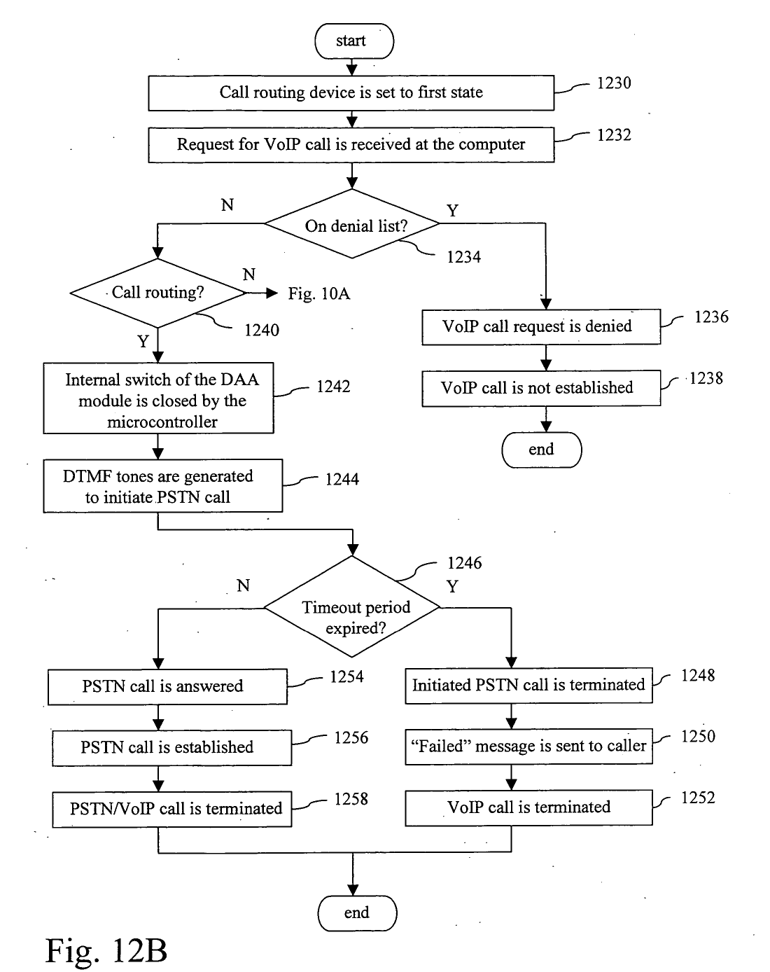

The process for routing an incoming PSTN call to a remote Internet-connected computer using the system 100 in accordance with an embodiment is described with reference to the flow diagram of FIG. 12A. This process is similar to a conventional call forwarding process in that a PSTN call to the system 100 is “forwarded” to another destination that can receive the PSTN call. However, unlike the conventional call forwarding process, the system 100 allows a PSTN call made to the system to be “forwarded” by automatically initiating a VoIP call and interconnecting the VoIP call with the received PSTN call. Thus, the system 100 interconnects established telephone calls, i.e., the received PSTN call and the initiated VoIP call, to “forward” the received PSTN call through the Internet to another destination, which may not be able to receive PSTN calls. This process allows a user to remotely access the system 100 using a PSTN call to make a VoIP call.

At block 1202, the call routing device 108 is set to the first state. Next, at block 1204, a request to establish a PSTN call in the form of ring signals from a remote telephone is received at call routing device 108. Next, at block 1206, the received ring signals are detected by the microcontroller 250 of the call routing device 108 via the ring detector 242. Next, at block 1208, the incoming PSTN call is automatically answered by the microcontroller 250. This is achieved by instructing the internal switch 302 of the DAA module 230 to close. The incoming PSTN call may be automatically answered after a predefined number of rings, which may be user-defined, or after one or more predefined keys on the dial pad are entered by the caller. At block 1208, the switching mechanism 249 of the call routing device 108 is also switched to a state that disconnects the telephone 102 from the PSTN 104 and the Internet-connected computer 110. Next, at block 1210, an audio option menu is played after the caller has entered a valid password. The option menu includes a call routing option via a VoIP call, as well as other options to access various functions of the system 100, such as administration options. If the call routing option is selected, the caller is prompt to enter a code, which may be a single digit number of a multi-digit number, that corresponds to an IP address to which a VoIP call is to be made. The code entered by the caller is then translated to a corresponding IP address by the call center program 620 using the address book, which includes codes for VoIP calls and their corresponding IP addresses.

Next, at block 1212, a request to establish a VoIP call is transmitted by the call center program 620 to a remote Internet-connected computer using the IP address that corresponds to the caller-entered code. Next, at block 1214, an informational voice message is sent back to the remote telephone via the PSTN call by the call center program 620, informing the caller that call forwarding (i.e., establishing a VoIP call) is in progress. Similar to the above-described process for making a VoIP call, one or more audio advertisements may also be sent back to the caller during the VoIP connecting period.

Next, at block 1216, the request is accepted or not accepted (timed out) at the remote Internet-connected computer. If the request is not accepted, the VoIP call is not established, at block 1218, and the call center program 620 may send a message to the remote telephone, informing the caller that call forwarding has failed, at block 1220. The process then comes to an end. However, if the request is accepted, the audio advertisements are stopped by the call center program 620, at block 1222, and the VoIP call is established, at block 1224. Since the internal switch 302 of the DAA module 230 is closed, the Internet-connected computer 110 is connected to the PSTN 104, which connects the PSTN call to the established VoIP call.

The PSTN/VoIP call is terminated when the caller hangs up the remote telephone, at block 1226. The on-hook status of the remote telephone is detected by the microcontroller 250 via the DAA module 230, which has a remote disconnect detection functionality. The on-hook status of the remote telephone is transmitted to the call center program 620. In response, the call center program 620 terminates the VoIP call. The PSTN/VoIP call is also terminated when the VoIP call connection becomes disconnected. When the disconnection of the VoIP call connection is detected by the call center program 620, the PSTN call is disconnected by the microcontroller 250 by opening the internal switch 302 of the DAA module 230.

The process for routing an incoming VoIP call to a remote telephone using the system 100 in accordance with an embodiment is described with reference to the flow diagram of FIG. 12B. This process is similar to the routing of an incoming PSTN call, as described above with reference to FIG. 12A. However, the process for routing an incoming VoIP call “forwards” the received VoIP call by initiating a PSTN call from the system 100 to a remote telephone and then interconnecting the received VoIP call with the initiated PSTN call.

At block 1230, the call routing device 108 is set to the first state. Next, at block 1232, a request to establish a VoIP call from a remote Internet-connected computer is received at the computer 100. Next, at block 1234, a determination is made by the call center program 620 whether the calling party is on the denial list. If so, the VoIP call request is automatically denied by the call center program 620, at block 1236, and the VoIP call is not established, at block 1238. The process then comes to an end.

However, if the calling party is not on the denial list, then a determination is made whether the call routing feature of the system has been activated by the user. If no, then the process proceeds to block 1012 of FIG. 10A. If yes, then the call center program 620 instructs the microcontroller 250 of the call routing device 108 to perform the following tasks to forward the VoIP call to a remote telephone using a phone number programmed by the user. At block 1242, the internal switch 302 of the DAA module 230 is closed by the microcontroller 250, connecting the DAA module to the PSTN 104. Next, at block 1244, DTMF tones that correspond to the forwarding phone number of the remote telephone are generated by the microcontroller 250 via the DTMF generator 246 to initiate a PSTN call to that telephone. Next, at block 1246, a determination is made by the microcontroller 250 whether a timeout period has expired. If so, the initiated PSTN call is terminated by the microcontroller 250 by opening the internal switch 302 of the DAA module 230, at block 1248, and an informational message may be sent to the remote Internet-connected computer by the call center program 620, at block 1250, informing the caller that call forwarding of the VoIP call has failed. Next, at block 1252, the VoIP call is terminated and the process comes to an end.

However, if the timeout period has not expired, then the process continues until the PSTN call is answered at the remote telephone, at block 1254. Next, at block 1256, the PSTN call is established. As a result, the incoming VoIP call is connected to the remote telephone via the newly established PSTN call, which effectively forwards the VoIP call to the remote telephone through the PSTN. The PSTN/VoIP call is terminated, at block 1258, under the same conditions as described above with reference to FIG. 12A.

After a received PSTN or VoIP call has been successfully routed by the system 100 to a remote destination, which can be a remote Internet-connected computer or a remote telephone, by initiating a VoIP or PSTN call and interconnecting the received call and the initiated call, a conference call between the parties of these interconnected calls and a third party at the system can be established. If such a conference call is desired, one of the parties of the interconnected calls can enter a conference command using, for example, the dial pad of a telephone or the keyboard of a computer to initiated the conference call. In response to the conference command, the switching mechanism 249 is switched by the microcontroller 250 to connect the off-hook detector 244 to the switching unit 214, which connects the telephone 102 to the PSTN 104 and the Internet 106 via the computer 110. Next, ring signals are generated by the microcontroller 250 via the ring signal generator 218 and transmitted through the relay 234 to the telephone 102 to ring the telephone. The conference call is established when ringing telephone 102 is answered by the third party.

In addition the above-described processes, the system 100 can also be configured to perform other telecommunication-related features, such as automatic call denial and voicemail for both VoIP and PSTN calls. The automatic call denial feature for VoIP calls has been described above with reference to FIGS. 10A, 10B and 12B. The voicemail feature for VoIP calls involves automatically answering an incoming VoIP call by the call center program 620, if the calling party is not on the denial list, and then allowing the caller to leave a digitally recorded message on the computer 110 after a greeting has been played to the caller. In one setting of the call center program 620, an incoming VoIP call may be automatically answered by the call center program as soon as a determination is made that the calling party is not on the denial list. In another setting of the call center program 620, an incoming call may be automatically answered by the call center program after ring signals has been generated and transmitted to the telephone 102 for a predefined period, allowing a user to answer the incoming call.

The automatic call denial feature for PSTN calls involves comparing the caller ID information, which is transmitted between the first and second ring signals from the PSTN 104, with the denial list by the call center program 620 and then allowing the subsequent ring signals to be transmitted to the telephone 102, only if the calling telephone is not on the denial list. Thus, the telephone 102 needs to be initially disconnected from the PSTN 104 by the switching mechanism 249 of the call routing device 108 so that the first ring signal is not transmitted to the telephone. The telephone 102 is connected to the PSTN 104 by the switching mechanism 249 only after the call center program 620 has determined that the calling telephone of an incoming PSTN call is not on the denial list. Furthermore, the internal switch 302 of the DAA module 230 is closed to transmit the caller ID information from the PSTN 104 to the call center program 620 in the computer 110.

The voicemail feature for PSTN calls involves automatically answering an incoming PSTN call after a predefined period, e.g., after receiving four ring signals from the PSTN 104, and then allowing the caller to leave a digital recording after a greeting has been played to the caller. When ring signals are received at the call routing device 108, the received ring signals are detected by the microcontroller 250 via the ring detector 242 or the DAA module 230 (assuming the relay 232 is not activated). After the predefined period, the incoming PSTN call is automatically answered by the microcontroller 250 by closing the internal switch 302 of the DAA module 230. The call center program 620 then plays a greeting to the caller and digitally records a voice message of the caller, if any.

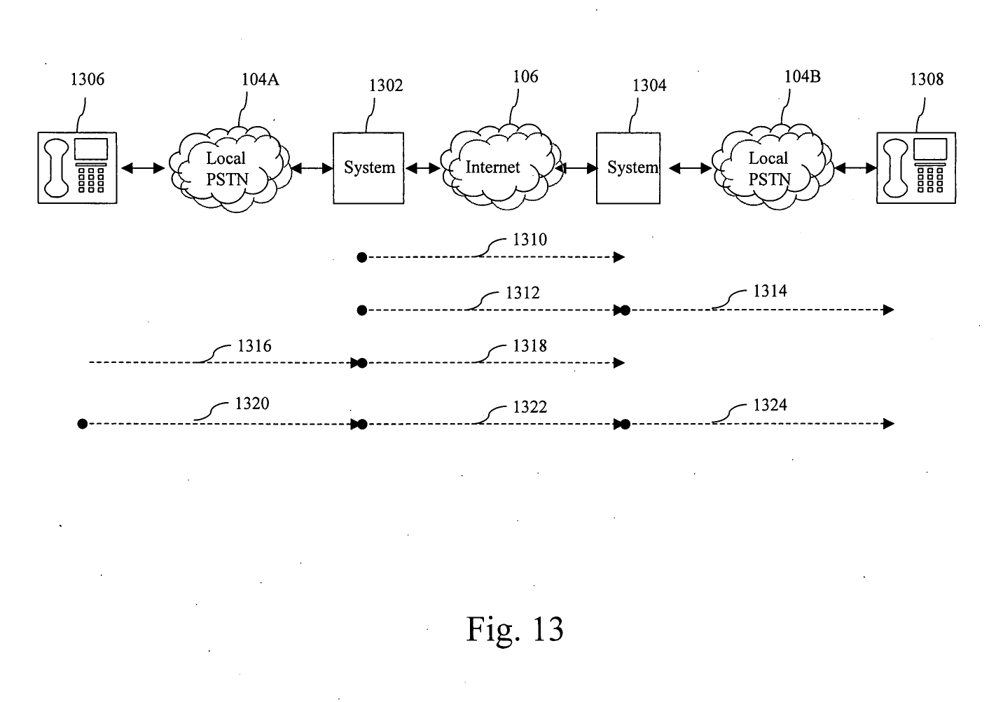

The system 100 may be used with other similar systems to enable different types of “long distance” calls between parties without incurring traditional long distance charges imposed by the telephone companies. As illustrated in FIG. 13, two systems 1302 and 1304 in accordance with an embodiment of the invention and two remote telephones 1306 and 1308 are shown. The systems 1302 and 1304 are similar to the system 100. Thus, each of the systems 1302 and 1304 can connect an incoming PSTN call to an outgoing VoIP call, initiated by that system, or vice versa, which results in forwarding of the incoming call to a desired remote Internet-connected computer or a desired remote telephone. The remote telephones 1306 may be any telephone connected to the PSTN 104. The remote telephones 1306 and 1308 may even be cellular phones connected to the PSTN 104 via a cellular phone network (not shown).

As shown in FIG. 13, the systems 1302 and 1304 are both connected to the Internet 106. The system 1302 is also connected to a local region 104A of the PSTN (“local PSTN”), while the system 1304 is connected to another local PSTN 104B. As an example, the local PSTN 104A may be the local telephone area of San Francisco in United States of America and the local PSTN 104B may be the local telephone area of Beijing in China. In this example, the system 1302 is physically located in San Francisco and the system 1304 is physically located in Beijing.

One type of “long distance” calls that can be made using the systems 1302 and 1304 is a VoIP call made from one system to the other system. As an example, using the telephone (not shown) of the system 1302 in San Francisco, a VoIP call can be made to the telephone (not shown) of the system 1304 in Beijing through the Internet 106, as indicated by the dotted line 1310. Thus, a “long distance” is made without the services of a long distance telephone company.

Another type of “long distance” calls using the systems 1302 and 1304 is a VoIP call made from one system to the other system that is forwarded to a remote telephone via a local PSTN call. As an example, using the telephone of the system 1302 in San Francisco, a VoIP call can be made to the telephone of the system 1304 in Beijing through the Internet 106, as indicated by the dotted line 1310. The VoIP call is then forwarded from the system 1304 to the remote telephone 1308 via a local PSTN call through the local PSTN 104B, as indicated by the dotted line 1314. Thus, a “long distance” call is made without the services of a long distance telephone company by simply making one local phone call from the system 1304 to the remote telephone 1308.

Another type of “long distance” calls using the systems 1302 and 1304 is a local PSTN call made from a remote telephone to one of the system that is forwarded to the other system. As an example, using the remote telephone 1306, a local PSTN call is made to the system 1302 in San Francisco through the local PSTN 104A, as indicated by the dotted line 1316. The PSTN call is then forwarded from the system 1302 in San Francisco to the system 1304 in Beijing via a VoIP call through the Internet 106, as indicated by the dotted line 1318. Again, a “long distance” is made without the services of a long distance telephone company by simply making one local phone call from the remote telephone 1306 to the system 1302.

Another type of “long distance” calls using the systems 1302 and 1304 is a local PSTN call made from a remote telephone to one of the system that is forwarded to the other system, which is then again forwarded to a remote telephone via a second local PSTN. As an example, using the remote telephone 1306, a local PSTN call is made to the system 1302 in San Francisco through the local PSTN 104A, as indicated by the dotted line 1320. The PSTN call is then forwarded from the system 1302 in San Francisco to the system 1304 in Beijing via a VoIP call through the Internet 106, as indicated by the dotted line 1322. The VoIP call is then forwarded from the system 1304 to the remote telephone 1308 via a second local PSTN call through the local PSTN 104B. Thus, a “long distance” is made without the services of a long distance telephone company by simply making a first local phone call from the remote telephone 1306 to the system 1302 and then making a second local phone call from the system 1304 to the remote telephone 1308.

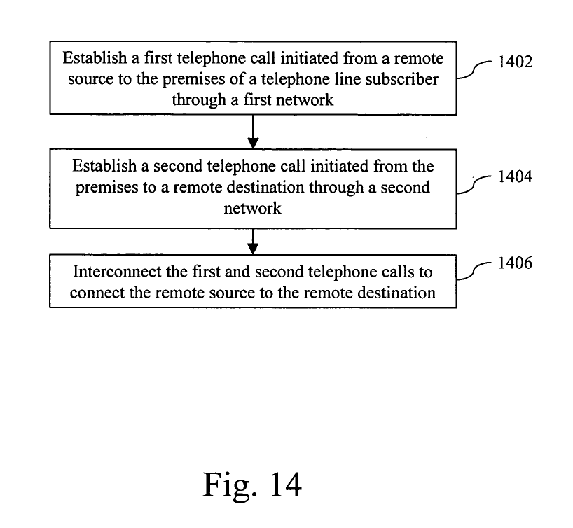

A method for managing voice communications in accordance with an embodiment of the invention is described with reference to the flow diagram of FIG. 14. At block 1402, a first telephone call initiated from a remote source to the premises of a telephone line subscriber through a first network is established. The first network is one of a circuit switching network and a packet switching network. Next, at block 1404, a second telephone call initiated from the premises to a remote destination through a second network is established. The second network is one of the circuit and packet switching networks that differs from the first network. Next, at block 1406, the first telephone call and the second telephone call are interconnected at the premises to connect the remote source and the remote destination.

Although specific embodiments of the invention have been described and illustrated, the invention is not to be limited to the specific forms or arrangements of parts so described and illustrated. The scope of the invention is to be defined by the claims appended hereto and their equivalents.

1. A method for managing voice communications comprising:
establishing a first telephone call initiated from a remote source to a premises of a telephone line subscriber through a first network, said first network being one of a circuit switching network and a packet switching network;
establishing a second telephone call initiated from said premises to a remote destination through a second network, said second network being one of said circuit switching network and said packet switching network that differs from said first network; and
interconnecting said first telephone call and said second telephone call at said premises to connect said remote source to said remote destination.

2. The method of claim 1 wherein said establishing of said first telephone call includes establishing said first telephone call made through the Public Switched Telephone Network.

3. The method of claim 1 wherein said establishing of said first telephone call includes establishing a Voice over Internet Protocol call through the Internet.

4. The method of claim 1 wherein said establishing of said second telephone call includes transmitting a request to establish a Voice over Internet Protocol call through said packet switching network to said remote destination from said premises.

5. The method of claim 4 wherein said transmitting of said request to establish said Voice over Internet Protocol call includes receiving a code from said remote source over said first telephone call that corresponds to an Internet Protocol address of said remote destination.

6. The method of claim 4 wherein said establishing of said second telephone call includes transmitting an audio advertisement to said remote source while said Voice over Internet Protocol call is being established.

7. The method of claim 1 wherein said establishing of said second telephone call includes generating dual tone multi-frequency tones to establish said second call through said circuit switching network in response to said first telephone call.

8. The method of claim 1 wherein said establishing of said first telephone call includes receiving a caller identification information of said first telephone call and determining whether said caller identification information is on a user-defined list to selectively establish said first telephone call.

9. The method of claim 8 further comprising generating particular ring signals in response said determining of whether said caller identification information is on said user-defined list.

10. The method of claim 1 further comprising establishing a connection between a telephone at said premises and said remote source and said remote destination through said first and second telephone calls.

11. The method of claim 10 further comprising ringing said telephone at said premises to establishing said connection in response to an entered command from one of said remote source and said remote destination.

12. A system for managing voice communications comprising:
a computer program running on a computing device in signal communication with a packet switching network, said computer program being configured to initiate and receive first telephone calls through said packet switching network; and
a routing device operatively coupled to said computing device, said routing device being configured to initiate and receive second telephone calls through a circuit switching network, said routing device being further configured to interconnect one of said first telephone calls and one of said second telephone calls to produce an interconnected call through said routing device.

13. The system of claim 12 wherein said routing device is configured to initiate and receive said second telephone calls made through the Public Switched Telephone Network.

14. The system of claim 12 wherein said computing program is configured to initiate and receive Voice over Internet Protocol calls through the Internet.

15. The system of claim 12 wherein said computing program is configured to transmit a request to establish a Voice over Internet Protocol call to a remote destination through said packet switching network in response to a first telephone call received from a remote source.

16. The system of claim 15 wherein said computer program is configured to transmit said request to establish said Voice over Internet Protocol call in response to a received code from said remote source over said first telephone call that corresponds to an Internet Protocol address of said remote destination.

17. The system of claim 15 wherein said computer program of claim is configured to transmits an audio advertisement to said remote destination while said Voice over Internet Protocol call is being established.

18. The system of claim 12 wherein said routing device includes a dual tone multi-frequency tone generator to generate dual tone multi-frequency tones to establish said second calls through said circuit switching network.

19. The system of claim 12 wherein said routing device includes a dual tone multi-frequency tone receiver to receive dual tone multi-frequency tones from said circuit switching network.

20. The system of claim 12 wherein said routing device includes a module configured to extract caller identification information from said first telephone calls and wherein said computer program is configured to determine whether said caller identification information for said first telephone calls are on a user-defined list to selectively establish said first telephone calls.

21. The system of claim 20 wherein said routing device is configured to generate particular ring signals in response a determination whether said caller identification information of a particular first telephone call is on said user-defined list.

22. The system of claim 12 wherein said routing device is coupled to a telephone, said routing device being configured to establish a connection between said telephone and said interconnected call to connect said remote source, said remote destination and said telephone.

23. The system of claim 22 wherein said routing device includes ring signal generator to transmit ring signals to said telephone to establish said connection between said telephone and said interconnected call.

24. A method for managing voice communications comprising:
receiving a first telephone call made from a remote source through a first network at a premises of a telephone line subscriber, said first network being one of a circuit switching network and a packet switching network;
initiating a second telephone call from said premises through said second network to a remote destination, said second network being one of said circuit switching network and said packet switching network that differs from said first network; and
interconnecting said first telephone call and said second telephone call at said premises to connect said remote source to said remote destination.

25. The method of claim 24 wherein said receiving of said first telephone call includes receiving said first telephone call made through the Public Switched Telephone Network.

26. The method of claim 24 wherein said receiving of said first telephone call includes receiving a Voice over Internet Protocol call through the Internet.

27. The method of claim 24 wherein said initiating of said second telephone call includes transmitting a request to establish a Voice over Internet Protocol call through said packet switching network to said remote destination from said premises.

28. The method of claim 27 wherein said transmitting of said request to establish said Voice over Internet Protocol call includes receiving a code from said first remote source over said first telephone call that corresponds to an Internet Protocol address of said remote destination.

29. The method of claim 27 wherein said initiating of said second telephone call includes transmitting an audio advertisement to said remote source while said Voice over Internet Protocol call is being initiated.

30. The method of claim 24 wherein said initiating of said second telephone call includes generating dual tone multi-frequency tones to establish said second call through said circuit switching network in response to said first telephone call.

31. The method of claim 24 wherein said initiating of said first telephone call includes receiving a caller identification information of said first telephone call and determining whether said caller identification information is on a user-defined list to selectively establish said first telephone call.

32. The method of claim 31 further comprising generating particular ring signals in response said determining of whether said caller identification information of said first telephone is on said user-defined list.

33. The method of claim 24 further comprising establishing a connection between a telephone at said premises and said remote source and said remote destination through said first and second telephone calls.

34. The method of claim 33 further comprising ringing said telephone at said premises to establishing said connection in response to an entered command from one of said remote source and said remote destination.
